(19) United States
(12) Patent Application Publication
(10) Pub. No.: US 2010/0126032 A1
(43) Pub. Date: May 27, 2010

(54) DUCTLESS DRYER

(75) Inventors: Yang-Ho Kim, Gyeongsangnam-Do (KR); Seung-Phyo Ahn, Gyeongsangnam-Do (KR); Sang-Ik Lee, Gyeongsangnam-Do (KR); Byeong-Jo Ryoo, Gyeongsangnam-Do (KR); Sung-Ho Song, Gyeongsangnam-Do (KR); Han-Yong Jung, Gyeongsangnam-Do (KR); Jae-Hyuk Wee, Gyeongsangnam-Do (KR); Yoon-Seob Eom, Gyeongsangnam-Do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/526,884

(22) PCT Filed: Feb. 13, 2008
(86) PCT No.: PCT/KR08/00849

§ 371 Date: Aug. 12, 2009

(30) Foreign Application Priority Data
Feb. 13, 2007 (KR) 10-2007-0015003

(51) Int. Cl. F26B 21/06; F26B 11/02

(52) U.S. Cl. 34/79; 34/132

(57) ABSTRACT

A ductless dryer is disclosed. The ductless dryer according to the present invention includes a hot air supply unit providing hot air into a drum and controlling heat for heating the air according to air volume, and a heat exchange unit dehumidifying humid air exhausted from the drum and controlling the amount of water used for dehumidifying according to a dew point temperature of the humid air.

### TECHNICAL FIELD

The present invention relates to a ductless dryer, and more particularly, to a ductless dryer which is capable of minimizing an amount of water used for dehumidifying humid air exhausted resulting from drying objects to be dried and of preventing stop of a gas combustion or turning on/off of a heater that frequently occurs when air volume in the dryer is reduced.

### BACKGROUND ART

Generally, a clothes dryer is an apparatus performing a drying operation on objects such as wet laundry to be dried by blowing hot air generated by a heater into a drum to absorb moisture from the objects therewithin. Dryers can be categorized as exhausting type dryers and condensing type dryers depending on the method employed for dealing with the humid air generated as the objects are dried by absorbing moisture therefrom.

In the exhausting type dryer, humid air exhausted from a drum is exhausted outside the dryer. However, an exhaust duct is required for exhausting the moisture evaporated from the objects in the drum to the outside of the dryer, and especially, the exhaust duct should be installed being extended a long distance to the outside of a room or building, because products of combustion such as carbon monoxide etc, are exhausted together with the moisture.

Meanwhile, in the condensing type dryer, the moisture in the humid air exhausted from the drum is condensed at a heat exchange unit to remove the moisture therefrom, and the dried air is recirculated back into the drum. However, a condensing type dryer does not facilitate to use gas as a heating source because a closed loop may be formed due to the flowing of the drying air.

In a ductless dryer, these disadvantages of the exhausting type and the condensing type dryers may be improved upon. That is, the ductless dryer has a configuration that it is not required to have an exhaust duct for exhausting the moisture evaporated in the drum installed to be extended a long distance to the outside of the room and to recirculate the dried air back into the drum after condensing the humid air exhausted from the drum in the heat exchange unit to remove the moisture.

However, in the ductless dryer, the air from the outside flows into the drum in a hot and dry state resulting from heating by a gas combustion or an electric heater. Here, in order to prevent damage on laundry or a fire, when the air volume in the dryer is reduced, the gas combustion is stopped or the heater is turned on/off, frequently, causing bad influence on the laundry or a safety of the dryer.

Also, the ductless dryer is provided with the heat exchange unit for removing the moisture contained in the humid air exhausted after drying the objects to be dried. The heat exchange unit is provided with a tube passing between fins. In order to remove the moisture, water having a temperature below a dew point temperature of the humid air flows through the tube, thereby condensing the humid air contacting with the fins. However, in the related art, even though it doesn't need to flow the water into the tube when the temperature of water is lower than the dew point temperature of the humid air, the water still flows into the tube without any control, thereby wasting the water.

### DISCLOSURE OF THE INVENTION

### Technical Problem

Therefore, it is an object of the present invention to provide a ductless dryer which is capable of preventing stop of a gas combustion or turning on/off of a heater that frequently occurs when air volume in the dryer is reduced.

Further, it is another object of the present invention to provide a ductless dryer which is capable of controlling an amount of water used for dehumidifying in a heat exchange unit according to a dew point temperature of humid air.

### Technical Solution

To achieve these objects, there is provided a ductless dryer comprising a main body, a drum rotatably installed at the main body, a hot air supply unit providing hot air into the drum, and a heat exchange unit dehumidifying humid air exhausted from the drum and controlling an amount of water for dehumidifying according to a dew point temperature of the humid air.

Here, preferably, the hot air supply unit may control the amount of heat supplied to heat air according to the amount of air introduced into the drum. Here, when time taken for the temperature of the air to reach a predetermined maximum temperature value after the initial drying process, the amount of heat supplied to heat the air may be reduced.

To perform this, preferably, the hot air supply unit may comprise a gas combustor for generating hot air by igniting gas after mixing with air, a gas valve for performing or stopping the gas supply to the gas combustor, a hot air supply duct by which the hot air generated from the gas combustor is introduced into the drum, and at least one hot air temperature sensor measuring a temperature of the hot air introduced into the drum. Alternately, preferably, the hot air supply unit may comprise a plurality of fixed heaters, a hot air supply duct by which the hot air generated from the fixed heaters is introduced into the drum, and at least one hot air temperature sensor measuring the temperature of the hot air introduced into the drum. Alternately, preferably, the hot air supply unit may comprise a fixed heater, at least one variable heater, a hot air supply duct by which the hot air generated from the fixed heater and the variable heater is introduced into the drum, and at least one hot air temperature sensor measuring a temperature of the hot air introduced into the drum.

Preferably, the heat exchange unit may comprise a heat exchanger, an air temperature sensor and a humidity sensor for calculating a dew point temperature of the humid air passing through the heat exchanger, a water temperature sensor measuring the temperature of water flowing in the heat exchanger, and a water amount valve by which the amount of water flowing in the heat exchanger is adjusted according to the dew point temperature of the humid air and the temperature of water. Here, preferably, the temperature and a humidity of the humid air measured by the air temperature sensor and the humidity sensor may be outputted as volt values, and the values are calculated into the dew point temperature through an operating formula pre-stored in a mi-com.

Preferably, the water amount valve is installed at an outlet of a tube passing through a first heat exchanger or at an inlet of a tube passing through a second heat exchanger, and accordingly, the water amount valve is closed in case that the temperature of water flowing in the tube of the first heat exchanger is lower than the dew point temperature of the humid air passing through the first heat exchanger and/or in case that the temperature of water flowing in the tube of the second heat exchanger is lower than the dew point temperature of the humid air passing through the second heat exchanger.

### BRIEF DESCRIPTION OF THE DRAWINGS

FIG. 1 is a schematic view showing a ductless dryer in accordance with one embodiment of the present invention;

FIG. 2 is a planar view showing the ductless dryer of FIG. 1;

FIG. 3 is a block diagram showing a first variation of a hot air supply unit in FIG. 2;

FIG. 4 is a block diagram showing a second variation of the hot air supply unit in FIG. 2;

FIG. 5 is a graph showing an air temperature at an inlet of a drum and an on/off cycle of a heater in case of the heater having a capacity of 5400 W;

FIG. 6 is a graph showing an air temperature at an inlet of a drum and an on/off cycle of a heater in case of the heater having a capacity of 4600 W;

FIG. 7 is a graph showing an air temperature at an inlet of a drum and an on/off cycle of a heater in case of the heater having a capacity of 4150 w;

FIG. 8 is a table comparing a drying performance according to a heater capacity;

FIG. 9 is an extracted view of a heat exchange unit in FIG. 2;

FIG. 10 is a graph showing a temperature and a humidity of humid air at a first position and a third position in FIG. 9; and

FIG. 11 is a graph showing a dew point temperature of humid air at a first position and a temperature of water flowing out a first heat exchanger in FIG. 9.

### MODES FOR CARRYING OUT THE PREFERRED EMBODIMENTS

Description will now be given in detail of the preferred embodiments of the present invention, examples of which are illustrated in the accompanying drawings.

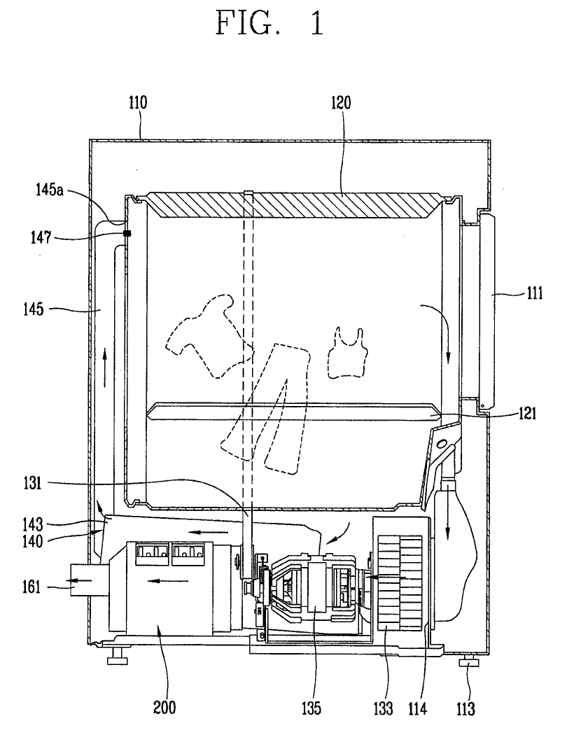

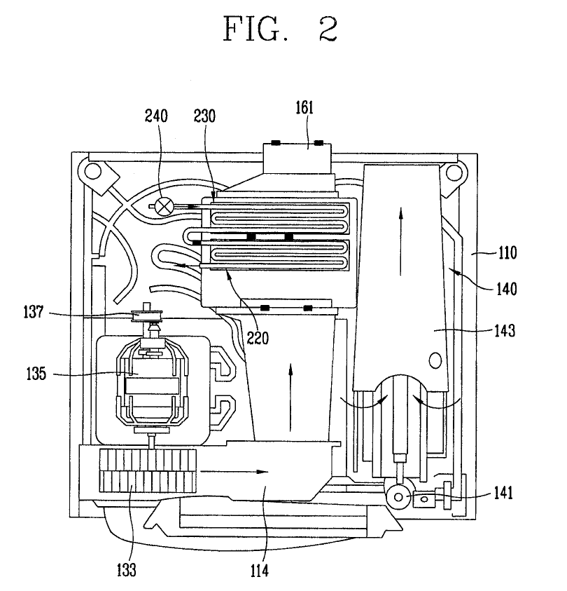

FIG. 1 is a schematic view showing the ductless dryer in accordance with one embodiment of the present invention, and FIG. 2 is a planar view showing the ductless dryer of FIG. 2. Arrows indicate flowing of air,

Referring to FIGS. 1 and 2, the ductless dryer in accordance with one embodiment of the present invention includes a main body 110, a drum 120 rotatably installed at the main body 110, a hot air supply unit 140 providing hot air into the drum 120 and controlling heat for heating the air according to air volume, and a heat exchange unit 200 dehumidifying humid air exhausted from the drum 120 and controlling the amount of water for dehumidifying according to a dew point temperature of the humid air.

A door 111 for putting clothes into the drum 120 is installed at a front side of the main body 110. And, a foot 113 supporting the main body 110 is installed at a lower side of the main body 110. The main body 110 has an inner space provided with a belt 131 rotating the drum 120, a fan 133 installed in a circulation duct 114, for providing a blowing force for air in the ductless dryer and a motor 135 providing the belt 131 and the fan 133 with a driving force. A pulley 137 by which the belt 131 is stopped is installed at a rotation shaft of the motor 135. Here, the motors 135 may be configured to be plural so as to provide the belt 131 and the fan 133 with the driving force, respectively. And, the circulation duct 114 is provided with a filter (not shown) for filtering lint such as a fluff and a waste thread contained in hot and humid air flowing out the drum 120.

The drum 120 is a container having an inner space for objects to be dried, such as clothes. A plurality of lifters 121 for lifting the clothes are installed therein.

The hot air supply unit 140 includes a gas valve 141 by which gas is supplied or blocked, a gas combustor 143 for generating hot air by igniting gas exhausted from the gas valve 141 after mixing with external air, a hot air supply duct 145 connecting the gas combustor 143 with the drum 120 so as to supply the generated hot air to the drum 120, and a hot air temperature sensor 147 measuring a temperature of the hot air introduced into the drum 120.

The hot air supply unit 140 is provided with a flame rod extended from an edge portion of a flame so as to detect a flame current and indirectly measure the amount of carbon monoxide (CO) through a value of the flame current.

When the amount of the carbon monoxide measured by the flame rod corresponds to a reference value high enough to badly influence on a human body, the gas valve 141 is closed to stop the combustion and an alarming sound informs a user of necessity to ventilate.

The gas combustor 143 connected to the gas valve 141 mixes gas exhausted from the gas valve 141 with the external air for the combustion and heats air using the heat generated therefrom. Hot air generated therefrom is provided into the drum 120 through the hot air supply duct 145.

The hot air temperature sensor 147 is installed at a connect portion 145a connecting the hot air supply duct 145 with the drum 120. The hot air temperature sensor 147 may be provided plurally and be installed in the hot air supply duct 145.

In case that the air volume in the dryer is reduced, such as lint caught in the filter interrupts flowing of the air, the air cannot be facilitated to flow due to too much laundry in the drum, the air volume in the dryer is reduced due to blocking of the duct connected to the outside, since the temperature of the air introduced into the drum 120 is higher than a reference temperature (i.e., a temperature applied to prevent damage on laundry or a fire), the laundry may be damaged.

To prevent the aforementioned, the hot air supply unit 140 adjusts the gas valve 141 according to the air volume and controls the amount of gas supplied to the gas combustor 143. That is, if a temperature measured by the hot air temperature sensor 147 exceeds a reference temperature range resulting from that the air volume is reduced, the gas valve 141 is closed partially or entirely so as to reduce or block the gas introduced into the gas combustor 143. In order to perform this, preferably, the gas valve 141 is implemented as a multiple stage solenoid valve by which an injection amount of gas can be minutely controlled.

Accordingly, the amount of heat supplied to the air introduced into the drum 120 can be reduced without frequently stopping the gas combustion so that the temperature of the air can be lowered. Accordingly, it is capable of preventing damage on the laundry and of enhancing a stability of the dryer.

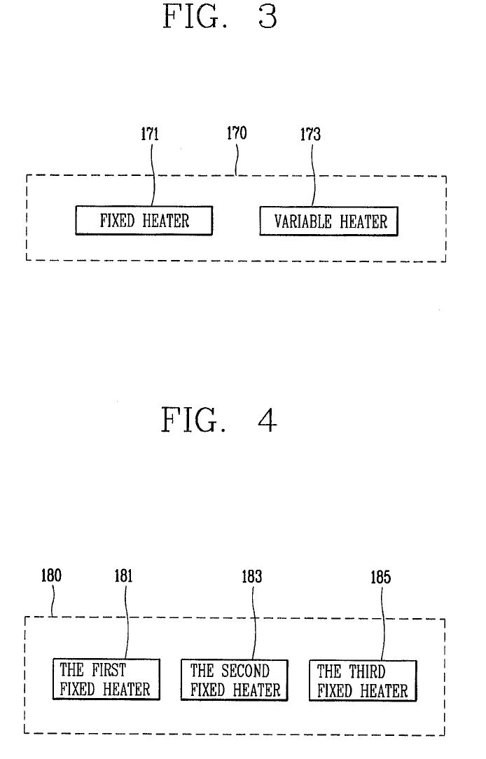

FIG. 3 is a block diagram showing a first variation of the hot air supply unit in FIG. 2, and FIG. 4 is a block diagram showing a second variation of the hot air supply unit in FIG. 2.

Referring to FIG. 3, the hot air supply unit 170 in accordance with the first variation includes a fixed heater 171 and a variable heater 173.

The fixed heater 171 handles 50% of the heater capacity, and the variable heater 173 is adjusted to handle the heater capacity 0˜50%. In detail, when the temperature of the air introduced into the drum 120 (refer to FIG. 1) is measured to be within a normal range by the hot air temperature sensor 147 (refer to FIG. 1) due to a normal air volume, the heater is controlled to handle the capacity of 100%. That is, the fixed heater 171 having the capacity of 50% is operated, and the variable heater 173 is fully operated to have the capacity of 50%.

However, when the temperature of the air introduced into the drum 120 (refer to FIG. 1) is measured to exceed the normal range by the hot air temperature sensor 147 (refer to FIG. 1) since the air volume is reduced, the heater is controlled to have the capacity reduced. That is, the fixed heater 171 having the capacity of 50% is operated, and the variable heater 173 is adjusted to have the capacity less than 50%. Accordingly, the amount of heat supplied to the air introduced into the drum 120 (refer to FIG. 1) is reduced so that the air temperature is lowered, thereby preventing damage on the laundry.

Here, whether or not the air volume is reduced is determined based on time taken for the temperature of the air introduced into the drum 120 (refer to FIG. 1) that is measured by the hot air temperature sensor 147 (refer to FIG. 1) to reach a predetermined maximum temperature value after the initial drying process. That is, the shorter the time duration is, the more the air volume is reduced.

Referring to FIG. 4, the hot air supply unit 180 in accordance with the second variation includes a plurality of fixed heaters.

In this embodiment, the fixed heaters include a first fixed heater 181 having the capacity of 50%, a second fixed heater 183 having the capacity of 30% and a third fixed heater 185 having the capacity of 20%.

In detail, when the temperature of the air introduced into the drum 120 (refer to FIG. 1) is measured to be within the normal range by the hot air temperature sensor 147 (refer to FIG. 1) due to the normal air volume, the heater is controlled to handle the capacity of 100%. That is, the first fixed heater 181, the second fixed heater 183 and the third fixed heater 185 are operated all together.

However, when the temperature of the air introduced into the drum 120 (refer to FIG. 1) is measured to exceed the normal range by the hot air temperature sensor 147 (refer to FIG. 1) since the air volume is reduced, the heater is controlled to have the capacity reduced. That is, the heater capacity is controlled by entirely or partially operating the first fixed heater 181, the second fixed heater 183 and the third fixed heater 185. Accordingly, the amount of heat supplied to the air introduced into the drum 120 (refer to FIG. 1) is reduced so that the temperature of air is lowered, thereby preventing damage on the laundry.

Here, likewise the first variation, whether or not the air volume is reduced is determined based on time taken for the temperature of air introduced into the drum 120 (refer to FIG. 1) that is measured by the hot air temperature sensor 147 (refer to FIG. 1) to reach a predetermined maximum temperature value after the initial drying process. That is, the shorter the time duration is, the more the air volume is reduced.

Hereafter, an on/off cycle and a drying performance of the heater according to the heater capacity will be described, in case that the heater capacity is variable such as the first and second variations.

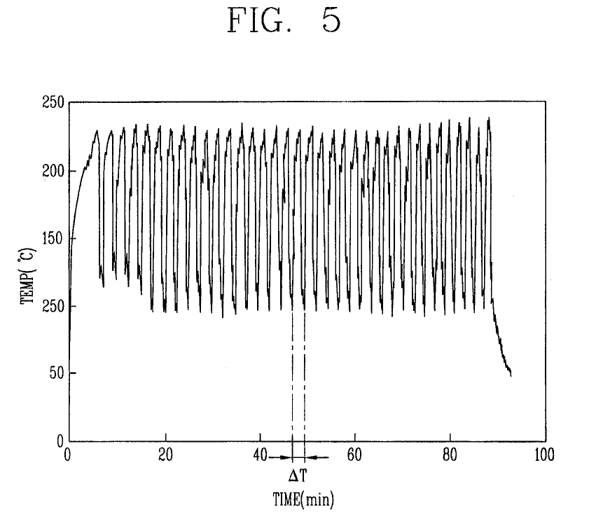

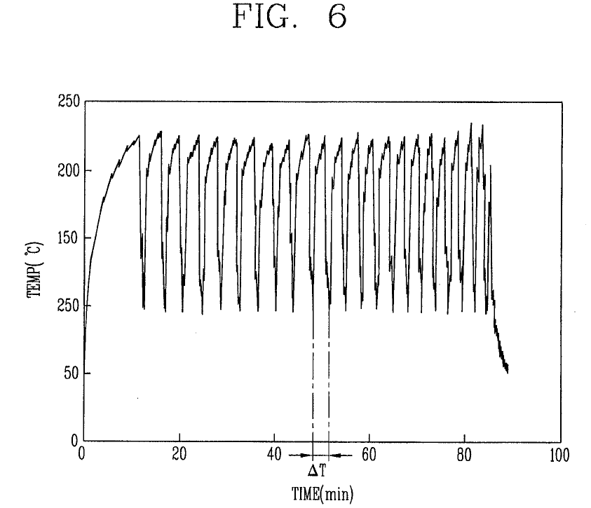

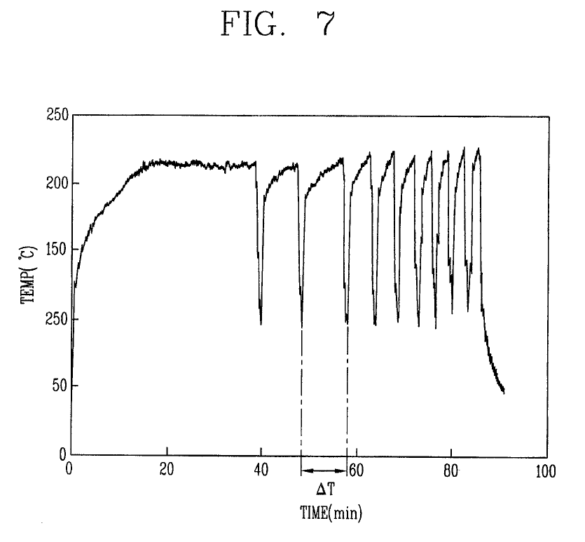

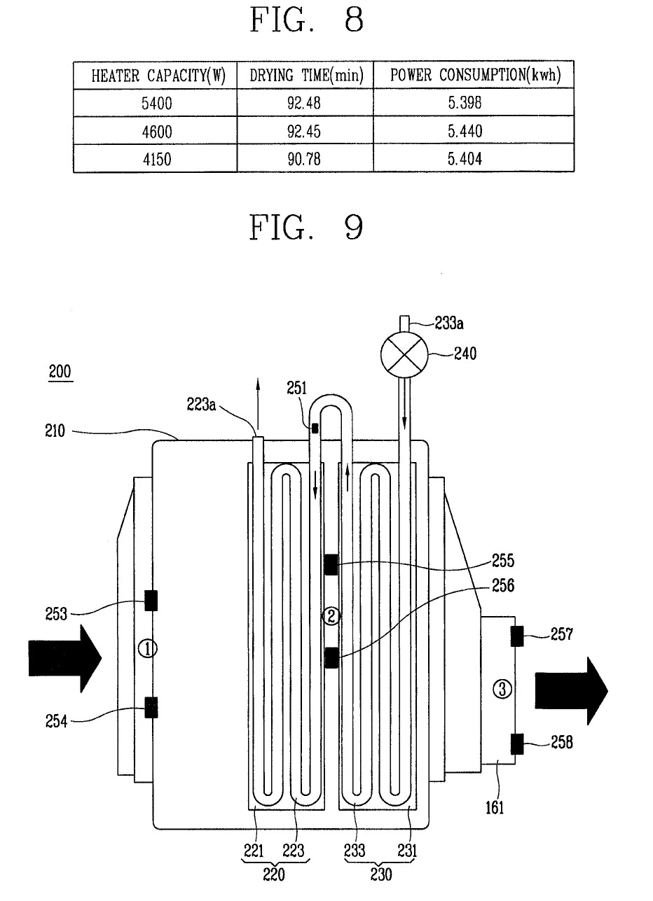

FIG. 5 is a graph showing the air temperature at an inlet of the drum and the on/off cycle of the heater in case of the heater having the capacity of 5400 W, FIG. 6 is a graph showing the air temperature at the inlet of the drum and the on/off cycle of the heater in case of the heater having the capacity of 4600 W, FIG. 7 is a graph showing the air temperature at the inlet of the drum and the on/off cycle of the heater in case of the heater having the capacity of 4150 W, and FIG. 8 is a table comparing the drying performance according to the heater capacity.

Referring to FIGS. 5 to 7, the on/off cycle is approximately 3 minutes and the air temperature is 225° C. in case of the heater capacity of 5400 W, and the on/off cycle is approximately 10 mins and the air temperature is 215° C. in case of the heater capacity of 4150 W. Thus, the smaller the heater capacity is, the lower the maximum temperature of the air flowing into the drum 120 (refer to FIG. 1) that is measured by the hot air temperature sensor 147 (refer to FIG, 1) becomes by more than 10˜20° C., and at the same time, the on/off cycle (ΔT) is increased, thus reducing the on/off frequency. But, the larger the heater capacity is, the shorter the time taken for the temperature to reach the maximum temperature at an early stage of the drying process (time taken to substantially and actively dried the laundry), accordingly it is more advantageous to shorten the drying time.

Referring to FIG. 8, when the air volume is insufficient, the drying time and a power consumption serving as main criteria for a drying performance show no degradation even when the heater capacity is reduced. That is, in case of the heater capacity of 5400 W, the drying time is 92.48 mins and the power consumption is 5,398 kwh, while in case of the heater capacity of 4150 W, the drying time is 90.78 mins and the power consumption is 5.404 kwh. Here, results from the two cases are not particularly different.

Accordingly, the amount of heat supplied to the air introduced into the drum 120 can be reduced without frequently turning on/off the heater so that the air temperature can be lowered. Accordingly, it is capable of preventing damage on the laundry and of enhancing a stability of the dryer.

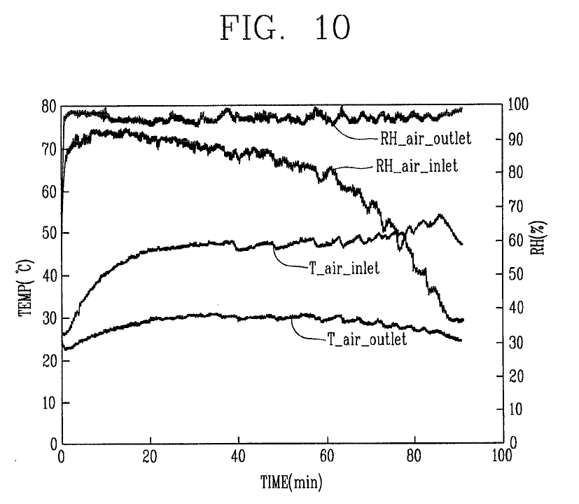

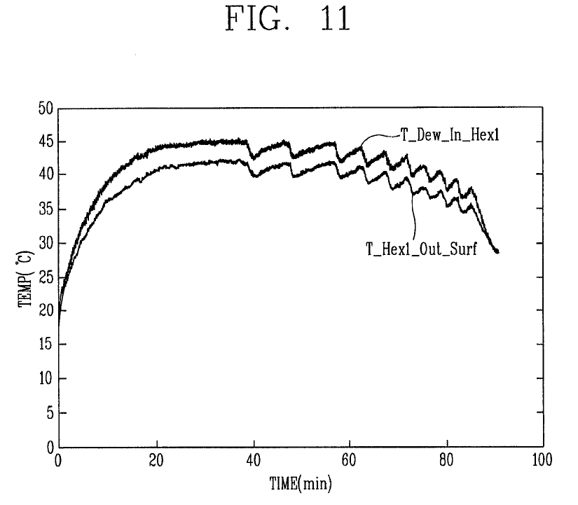

FIG. 9 is an extracted view of the heat exchange unit in FIG. 2, FIG. 10 is a graph showing the temperature and a humidity of humid air at a first position (\textcircled{1}) and a third position (\textcircled{3}) in FIG. 9, and FIG. 11 is a graph comparing a dew point temperature of humid air at the first position (\textcircled{1}) and the temperature of water flowing out of a first heat exchanger in FIG. 9. A thick arrow indicates flowing of the humid air passing through the heat exchange unit, and a thin arrow indicates flowing of the water passing through a tube.

Referring to FIG. 9, the heat exchange unit 200 includes a case 210 forming a receiving space, at least one heat exchanger received in the case 210, an air temperature sensor and a humidity sensor for calculating the dew point temperature of the humid air passing through the heat exchanger, a water temperature sensor 251 for measuring the temperature of water flowing in the heat exchanger, and a water amount valve 240 for controlling the amount of water flowing in the heat exchanger according to the calculated dew point temperature of the humid air.

A water container (not shown) for collecting condensed water generated in a condensing process and dropping is provided at the lower portion of the case 210.

The heat exchanger includes a first exchanger 220 and a second heat exchanger 230. The heat exchanger may be configured in single or the number of three or more if necessary.

The first heat exchanger 220 is composed of a fin 221 and a tube 223. In the first heat exchanger 220, hot and humid air flowing out of the drum 120 is condensed by low-temperature water and dried by a heat exchanging manner between air and water. The first heat exchanger 220 is installed at a left side of the case 210 (refer to FIG. 1) so as to be located in an outlet end of the circulation duct 114 (refer to FIG. 2) connected with the drum 120.

The fin 221 is implemented as a plurality of thin plates stacked to each other with a minute gap therebetween so as to pass through the hot and humid air by vertically contacting thereto. Here, the thin plate is formed by a metallic material having an excellent conductivity.

The low-temperature (22° C.) water is circulated in the tube 223. And, the tube 223 is penetratingly formed at the fin 221 in a reciprocating manner.

Likewise the first heat exchanger 220, the second heat exchanger 230 is composed of a fin 231 and a tube 233. In the second heat exchanger 230, the dehumified air flowing out of the first heat exchanger 220 is condensed by the low-temperature water and dried once more by the heat exchanging manner between air and water. The second heat exchanger 230 is installed at a right side of the case 210 so as to be located in an Inlet end of the exhaust duct 161 (refer to FIG. 1).

The fin 231 is Implemented as the plurality of thin plates stacked to each other with the minute gap therebetween so as to pass through the hot and humid air by vertically contacting thereto. Here, the thin plate is formed by a metallic material having the excellent conductivity.

The low-temperature (22° C.) water is circulated in the tube 233. And, the tube 233 is penetratingly formed at the fin 231 in the reciprocating manner.

And, the tube 223 of the first heat exchanger 220 and the tube 233 of the second heat exchanger 230 are connected with each other at a middle position between the first heat exchanger 220 and the second heat exchanger 230.

And, an inlet 233a of the tube 233 of the second heat exchanger 230 and an outlet 223a of the tube 223 of the first heat exchanger 220 are connected to a water hose (not shown) connected to an external water supplying source so as to receive water from the outside.

The water introduced into the inlet 233a of the tube 233 of the second heat exchanger 230 through the water hose passes through the water amount valve 240 and the tubes 233, 223, and then cools the fin 231 of the second heat exchanger 230 and the fin 221 of the first heat exchanger 220. And after, the water flows into the water hose through the outlet 223a of the tube 223 of the first heat exchanger 220.

Meanwhile, in order to dehumidify the humid air at the heat exchange unit 200, a status amount of the humid air passing through the first heat exchanger 220 and the second heat exchanger 230 should be detected.

That is, the dew point temperature proper to condense moisture on the fin 221 of the first heat exchanger 220 and the fin 231 of the second heat exchanger 230 and corresponding amount of water to be supplied can be controlled only after detecting the status amount of the humid air.

There may be a plurality of factors to determine the status amount of the humid air, for example, temperature/humidity of external air introduced into the heater or a gas burner according to the season, the temperature of water supplied to the heat exchanger, variation in a moisture content of laundry in the drum during the drying process and the temperature/humidity of peripheral air of the dryer.

Thus, only if the status of the humid air is detected at the inlet of the first heat exchanger 220 (hereafter, the first position (\textcircled{1})), between the first heat exchanger 220 and the second heat exchanger 230 (hereafter, the second position (\textcircled{2})), and the outlet of the second heat exchanger 230 (hereafter, the third position (\textcircled{3})) considering all the factors above, the water amount can be actively controlled, thereby being capable of reducing the amount of water used.

To perform this, an air temperature sensor 253 and a humidity sensor 254 are installed at the first position (\textcircled{1}), and an air temperature sensor 255 and a humidity sensor 256 are installed at the second position (\textcircled{2}). Also, an air temperature sensor 257 and a humidity sensor 258 are installed at the third position (\textcircled{3}).

Referring to FIG. 10, an RH_air_outlet indicates a relative humidity of the humid air measured by the humidity sensor 258 at the third position (\textcircled{3}), a T_air_inlet indicates the temperature of the humid air measured by the air temperature sensor 253 at the first position (\textcircled{1}), and a T_air_outlet indicates the temperature of the humid air measured by the air temperature sensor 257 at the third position (\textcircled{3}).

The temperature and the humidity of the humid air measured by the air temperature sensors 253, 255, 257 and the humidity sensors 254, 256, 258 are outputted as volt values. And, the values are calculated into the dew point temperatures at the first position (\textcircled{1}), the second position (\textcircled{2}) and the third position (\textcircled{3}) through an operating formula pre-stored in a mi-com (not shown).

More particularly, in order to detect the status amount of the air, data regarding to a dry bulb temperature and a wet bulb temperature (or relative humidity) at the first, second and third positions are collected by the air temperature sensors 253, 255, 257 and the humidity sensors 254, 256, 258, and the mi-com (not shown) serves to calculate each dew point temperature at the first, second and third positions using the collected data.

The water temperature sensor 251 is installed on the tubes 223, 233 introduced into the second heat exchanger 230 from the first heat exchanger 220 so as to measure the temperature of the water flowing in the tubes 223, 233.

The water amount valve 240 is installed at the inlet 233a of the tube 233 passing through the second heat exchanger 230 so as to control the amount of water introduced into the tube 233. The water amount valve 240 can be installed at the outlet 223a of the tube 223 passing through the first heat exchanger 220 if necessary. Here, the water amount valve 240 may be selectively implemented as one of an analog type valve that can be consecutively switched and a digital type valve that is switched by on and off signals and relatively cheap. To perform a minute controlling, the water amount valves 240 may be used in plural.

Referring to FIGS. 9 and 11, since the dew point temperature (T_Dew_In_Hex1) of the humid air at the first position (\textcircled{1}) is lower than the temperature (T_Hex1_Out_Surf) of the water flowing in the tube 223, the humid air is uniformly condensed at the entire fin 221 of the first heat exchanger 220. Here, the water amount valve 240 is closed so as not to allow the water to flow into the tube 223 any more, thereby reducing the amount of water used.

If the water temperature measured by the water temperature sensor 251 is higher than the calculated dew point temperature, the water amount valve 240 is opened so as to allow the water to be supplied more, thereby lowering the temperature of the surface of the fin 221 of the first heat exchanger 220 and the temperature of the surface of the fin 221 of the second heat exchanger 230 to be lower than a condensation temperature.

According to the aforementioned configuration, the temperature of the surface of the fin 221 of the first heat exchanger 220 is maintained below the dew point temperature of the humid air at the first position (\textcircled{1}) and the temperature of the surface of the fin of the second heat exchanger 230 is maintained below the dew point temperature of the humid air at the second position (\textcircled{2}) with controlling the amount of water used, thereby reducing the amount of water used with a maximum efficiency of the heat exchanger.

Meanwhile, it is capable of reducing the amount of water used with simple and a low cost.

As the simplest method, when the dryer is cooled without any control, the water amount valve 240 may be entirely closed, thereby reducing the amount of water used.

And, by receiving the temperature of water supplied into the heat exchange unit 200, the valve is adjusted by the plurality of stages corresponding to temperature ranges estimated through experiments performed for a product development, thereby controlling the amount of water used.

And, in the related dryer, it is started that the water amount is purposely reduced or the water supply is stopped from when the drying process is almost finished, that is when the graph is drastically dropped down, by analyzing signals of an electrode sensor or the humidity sensor that is used for the determination, thereby minimizing damage caused by the moisture exhausted to the outside of the dryer and reducing the amount of water used.

The ductless dryer in accordance with the present invention may have the following advantages.

First, when the air volume is reduced, and thus the temperature value measured by the hot air temperature sensor is greater than the reference value, the amount of gas introduced into the gas combustor is reduced or the gas supply is stopped by closing the gas valve partially or entirely. Accordingly, the heat supplied to the air introduced into the drum is reduced without frequently stopping the gas combustion thus the temperature of the air is lowered, thereby being capable of preventing damage on laundry and of enhancing the stability of the dryer.

Second, when the air volume is reduced, and thus the temperature value measured by the hot air temperature sensor is greater than the reference value, the heater capacity is varied. Accordingly, the heat supplied to the air introduced into the drum is reduced without frequently turning on/off the heater thus the temperature of the air is lowered, thereby being capable of preventing damage on laundry and of enhancing the stability of the dryer.

Third, the temperature of the heat exchanger is maintained below the dew point of the humid air with controlling the amount of water used, thereby being capable of maximizing the efficiency of the heat exchanger and of reducing the amount of water used.

The ductless dryer in accordance with the present Invention can be used domestically, commercially and industrially.

It will also be apparent to those skilled in the art that various modifications and variations can be made In the present invention without departing from the spirit or scope of the invention. Thus, it is intended that the present invention cover modifications and variations of this invention provided they come within the scope of the appended claims and their equivalents.

1. A ductless dryer comprising:
a main body;
a drum rotatably installed at the main body;
a hot air supply unit providing hot air into the drum; and
a heat exchange unit dehumidifying humid air exhausted from the drum and controlling an amount of water for dehumidifying according to a dew point temperature of the humid air.

2. The ductless dryer of claim 1, wherein the hot air supply unit controls the amount of heat supplied to heat air according to the amount of air introduced into the drum.

3. The ductless dryer of claim 2, wherein the hot air supply unit reduces the amount of heat supplied to heat the air when time taken for the temperature of the air to reach a predetermined maximum temperature value after the initial drying process.

4. The ductless dryer of claim 2, wherein the hot air supply dryer comprises:
a gas combustor for generating hot air by igniting gas after mixing with air;
a gas valve for performing or stopping the gas supply to the gas combustor;
a hot air supply duct by which the hot air generated from the gas combustor is introduced into the drum; and
at least one hot air temperature sensor measuring a temperature of the hot air introduced into the drum.

5. The ductless dryer of claim 4, wherein the gas valve is implemented as a multiple stage solenoid valve by which an injection amount of gas can be minutely controlled.

6. The ductless dryer of claim 2, wherein the hot air supply unit comprises:
a plurality of fixed heaters;
a hot air supply duct by which the hot air generated from the fixed heaters is introduced into the drum; and
at least one hot air temperature sensor measuring the temperature of the hot air introduced into the drum.

7. The ductless dryer of claim 2, wherein the hot air supply unit comprises:
a fixed heater;
at least one variable heater;
a hot air supply duct by which the hot air generated from the fixed heater and the variable heater is introduced into the drum; and
at least one hot air temperature sensor measuring a temperature of the hot air introduced into the drum.

8. The ductless dryer of claim 4, wherein the hot air temperature sensor is installed at a connect portion connecting the hot air supply duct with the drum.

9. The ductless dryer of claim 1, wherein the heat exchange unit comprises:
a heat exchanger;
an air temperature sensor and a humidity sensor for calculating a dew point temperature of the humid air passing through the heat exchanger;
a water temperature sensor measuring the temperature of water flowing in the heat exchanger; and
a water amount valve by which the amount of water flowing in the heat exchanger is adjusted according to the dew point temperature of the humid air and the temperature of water.

10. The ductless dryer of claim 9, wherein the temperature and a humidity of the humid air measured by the air temperature sensor and the humidity sensor are outputted as volt values, and the values are calculated into the dew point temperature through an operating formula pre-stored in a mi-com.

11. The ductless dryer of claim 9, wherein the heat exchanger comprises:
a first heat exchanger; and
a second heat exchanger disposed to allow the air flowing out of the first heat exchanger to be introduced thereinto.

12. The ductless dryer of claim 11, wherein the air temperature sensor is installed at at least one of an inlet of the first heat exchanger, between the first heat exchanger and the second heat exchanger, and an outlet of the second heat exchanger.

13. The ductless dryer of claim 11, wherein the humidity sensor is installed at at least one of an inlet of the first heat exchanger, between the first heat exchanger and the second heat exchanger, and an outlet of the second heat exchanger.

14. The ductless dryer of claim 11, wherein the first heat exchanger and the second heat exchanger are provided with a plurality of fins and tubes passing therethrough, and the water temperature sensor measures the temperature of water flowing in the tube.

15. The ductless dryer of claim 11, wherein the water amount valve is installed at an outlet of a tube passing through the first heat exchanger.

16. The ductless dryer of claim 11, wherein the water amount valve is installed at an inlet of a tube passing through the second heat exchanger.

17. The ductless dryer of claim 11, wherein the water amount valve is closed in case that the temperature of water flowing in a tube of the first heat exchanger is lower than the dew point temperature of the humid air passing through the first heat exchanger and/or in case that the temperature of water flowing in the tube of the second heat exchanger is lower than the dew point temperature of the humid air passing through the second heat exchanger.

18. The ductless dryer of claim 5, wherein the hot air temperature sensor is installed at a connect portion connecting the hot air supply duct with the drum.

19. The ductless dryer of claim 6, wherein the hot air temperature sensor is installed at a connect portion connecting the hot air supply duct with the drum.

20. The ductless dryer of claim 7, wherein the hot air temperature sensor is installed at a connect portion connecting the hot air supply duct with the drum.
